(19) United States
(12) Patent Application Publication
(10) Pub. No.: US 2023/0214262 A1
(43) Pub. Date: Jul. 6, 2023

(54) ELECTRONIC DEVICE FOR MANAGING MEMORY, OPERATION METHOD OF ELECTRONIC DEVICE, AND NON-TRANSITORY STORAGE MEDIUM

(71) Applicant: SAMSUNG ELECTRONICS CO., LTD., (US)

(72) Inventors: Jiman KWON, Suwon-si (KR); Dongho KIM, Suwon-si (KR); Hakryoul KIM, Suwon-si (KR); Jaehyeon PARK, Suwon-si (KR); Jiseop SONG, Suwon-si (KR); Jooyong SIN, Suwon-si (KR); Dongwook LEE, Suwon-si (KR)

(73) Assignee: SAMSUNG ELECTRONICS CO., LTD.

(21) Appl. No.: 18/120,190

(22) Filed: Mar. 10, 2023

Related U.S. Application Data
(63) Continuation of application No. PCT/KR2021/012240, filed on Sep. 8, 2021.

(30) Foreign Application Priority Data
Sep. 10, 2020 (KR) 10-2020-0116353

(51) Int. Cl. G06F 9/50

(52) U.S. Cl. CPC G06F 9/5016; G06F 9/5044

(57) ABSTRACT

In some embodiments, an electronic device includes a memory and at least one processor coupled to the memory. The memory stores instructions configured to cause the electronic device to: retrieve data of at least one process allocated to the memory and perform a first memory retrieval operation; identify an available capacity of the memory, based on an event generated by the first memory retrieval operation; perform a second memory retrieval operation, based on a value of the identified available capacity being less than or equal to a first threshold value and the identified available capacity being greater than a second threshold value; and perform a third memory retrieval operation, based on a value of the identified available capacity being less than or equal to the first threshold value and the identified available capacity being less than or equal to the second threshold value.

### CROSS-REFERENCE TO RELATED APPLICATIONS

This application is a continuation application of International Application No. PCT/KR2021/012240, filed on Sep. 8, 2021, which claims priority to Korean Patent Application 10-2020-0116353, filed on Sep. 10, 2020, in the Korean Intellectual Property Office, the disclosures of which are incorporated by reference herein in their entireties.

### BACKGROUND

### 1. Field

The present disclosure relates generally to electronic devices, and more particularly, to an electronic device for managing a memory, a method of operating an electronic device, and a non-transitory storage medium.

### 2. Description of Related Art

A related electronic device may be configured in terms of hardware and software. In terms of hardware, the related electronic device may include a processor (e.g., a central processing unit (CPU) and/or a system on chip (SOC)) configured to perform calculations and/or control and execution of processes. Alternatively or additionally, the related electronic device may include a memory in which data for the processes that are executed may be loaded. In terms of software, the related electronic device may include an operating system (and/or kernel) configured to perform basic management of a system and an application run on the operating system to execute the processes. For example, the processor (e.g., CPU) may load data corresponding to the operating system into the memory, execute the data, load an application into the memory, and execute the application on the operation system while the operating system is being executed. Furthermore, the execution of the application may include performing the processes.

In some related electronic devices, various applications may be included that may provide various services. Thus, the management of the memory into which applications are loaded and executed may be an important consideration, particularly when various applications may be simultaneously executed.

As a plurality of applications may be simultaneously executed and processes of the plurality of applications may be repeatedly executed and ended during a time period, a related electronic device may have an increased amount of memory that is occupied by data of the processes that may loaded into the memory. Consequently, the related electronic device may have a decreased available memory capacity. When the available memory capacity of the related electronic device becomes smaller (less) than or equal to a specified limit value, the related electronic device may perform an operation of decreasing the used memory capacity and increasing the available memory capacity that may be available to execute the processes.

As a number of memory-intensive processes (e.g., processes that may require a large amount of memory when compared to an amount of memory (e.g., random access memory (RAM) installed on the related electronic device) increase, an operating system of the related electronic device may perform a plurality of related memory retrieval operations as part of operations for increasing the available capacity of the memory. Such related memory retrieval operations may generate a processing load of a processor (e.g., CPU), which may result in the operation of the processor being delayed due to the increased load of the processor. Consequently, the performance of the related electronic device may deteriorate.

Alternatively or additionally, the related electronic device may need to monitor a memory state because of a limited memory (e.g., RAM) capacity and to secure the available capacity of the memory in order to maintain performance of the related electronic device at an allowed level.

### SUMMARY

According to various embodiments of the present disclosure, an electronic device, an operation method of the electronic device, and a non-transitory storage medium for managing a memory to secure the available capacity of the memory may be provided.

According to an embodiment of the disclosure, an electronic device includes a memory, and at least one processor electrically connected to the memory, wherein the memory stores instructions configured to, when executed by the at least one processor, cause the electronic device to based on identifying that the first available capacity of the memory for allocating a process to the memory is less than a capacity threshold, retrieve some data of at least one process allocated to the memory and perform a first memory retrieval operation for increasing an available capacity of the memory, identify the available capacity of the memory, based on an event generated by the first memory retrieval operation, perform a second memory retrieval operation, based on a value of the identified available capacity being less than or equal to than a first threshold value and the identified available capacity being greater than a second threshold value, and perform a third memory retrieval operation, based on a value of the identified available capacity being less than or equal to than the first threshold value and the identified available capacity being less than or equal to than the second threshold value, and the first threshold value is greater than the second threshold value.

According to an embodiment of the disclosure, an operation method of an electronic device, comprises based on identifying that an available capacity for allocating a process to a memory of the electronic device is less than a capacity threshold, retrieving data of at least one process allocated to the memory and performing a first memory retrieval operation for increasing an available capacity of the memory, identifying the available capacity of the memory, based on an event generated by the first memory retrieval operation, performing a second memory retrieval operation, based on a value of the identified available capacity being less than or equal to a first threshold value and the identified available capacity being greater than a second threshold value, and performing a third memory retrieval operation, based on a value of the identified available capacity being less than or equal to the first threshold value and the identified available capacity being less than or equal to the second threshold value, and the first threshold value is greater than the second threshold value.

According to an embodiment of the disclosure, a non-transitory computer-readable storage medium storing programs for operating an electronic device, the programs comprising executable instructions configured to, when executed by a processor of the electronic device, cause the electronic device to, based on identifying that a first available capacity for allocating a process to a memory of the electronic device is less than a capacity threshold, retrieve data of at least one process allocated to the memory and perform a first memory retrieval operation for increasing an available capacity of the memory, identify the available capacity of the memory, based on an event generated by the first memory retrieval operation, perform a second memory retrieval operation, based on a value of the identified available capacity being less than or equal to a first threshold value and the identified available capacity being greater than a second threshold value, and perform a third memory retrieval operation, based on a value of the identified available capacity being less than or equal to the first threshold value and the identified available capacity being less than or equal to the second threshold value, wherein the first threshold value is greater than the second threshold value.

According to an electronic device and an operation method of the electronic device according to an embodiment, the electronic device may end a process allocated to a memory faster than a related electronic device by executing a third memory retrieval operation. Accordingly, the electronic device may secure an available capacity of the memory to rapidly escape from an out-of-memory state and reduce load of the processor according to execution of a first memory retrieval operation (a first operation and/or a second operation). As a result, the electronic device may obtain an effect of improving the performance of the electronic device when compared to a related electronic device.

Additional aspects will be set forth in part in the description which follows and, in part, will be apparent from the description, or may be learned by practice of the presented embodiments.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates a network environment, according to various embodiments;

FIG. 2 illustrates an example of a configuration of an electronic device, according to an embodiment.

FIG. 3 illustrates an operation method of the electronic device, according to an embodiment.

FIG. 4 illustrates an example of the operation method by the first memory retrieval operation of the electronic device according to an embodiment.

FIG. 5 illustrates an example of a first memory retrieval operation of the electronic device according to an embodiment.

FIG. 6 illustrates an example of the operation method by the second and third memory retrieval operations of the electronic device according to an embodiment.

FIG. 7 illustrates an example of second and third memory retrieval operations of the electronic device according to an embodiment.

FIG. 8 illustrates an example of the operation of the electronic device according to an embodiment.

FIG. 9 illustrates an example of an operation graph based on the operation of the electronic device according to an embodiment.

In connection with description of drawings, the same or similar reference numerals may be used for the same or similar elements.

### DETAILED DESCRIPTION

The following description with reference to the accompanying drawings is provided to assist in a comprehensive understanding of embodiments of the present disclosure defined by the claims and their equivalents. Various specific details are included to assist in understanding, but these details are considered to be exemplary only. Therefore, those of ordinary skill in the art will recognize that various changes and modifications of the embodiments described herein can be made without departing from the scope and spirit of the disclosure. In addition, descriptions of well-known functions and structures are omitted for clarity and conciseness.

Reference throughout the present disclosure to “one embodiment,” “an embodiment,” “an example embodiment,” or similar language may indicate that a particular feature, structure, or characteristic described in connection with the indicated embodiment is included in at least one embodiment of the present solution. Thus, the phrases “in one embodiment”, “in an embodiment,” “in an example embodiment,” and similar language throughout this disclosure may, but do not necessarily, all refer to the same embodiment.

It is to be understood that the specific order or hierarchy of blocks in the processes/flowcharts disclosed are an illustration of exemplary approaches. Based upon design preferences, it is understood that the specific order or hierarchy of blocks in the processes/flowcharts may be rearranged. Further, some blocks may be combined or omitted. The accompanying claims present elements of the various blocks in a sample order, and are not meant to be limited to the specific order or hierarchy presented.

Hereinafter, an electronic device according to various embodiments is described with reference to the accompanying drawings. The term user used in various embodiments may be a person using an electronic device or a device (e.g., an artificial intelligence electronic device) using an electronic device.

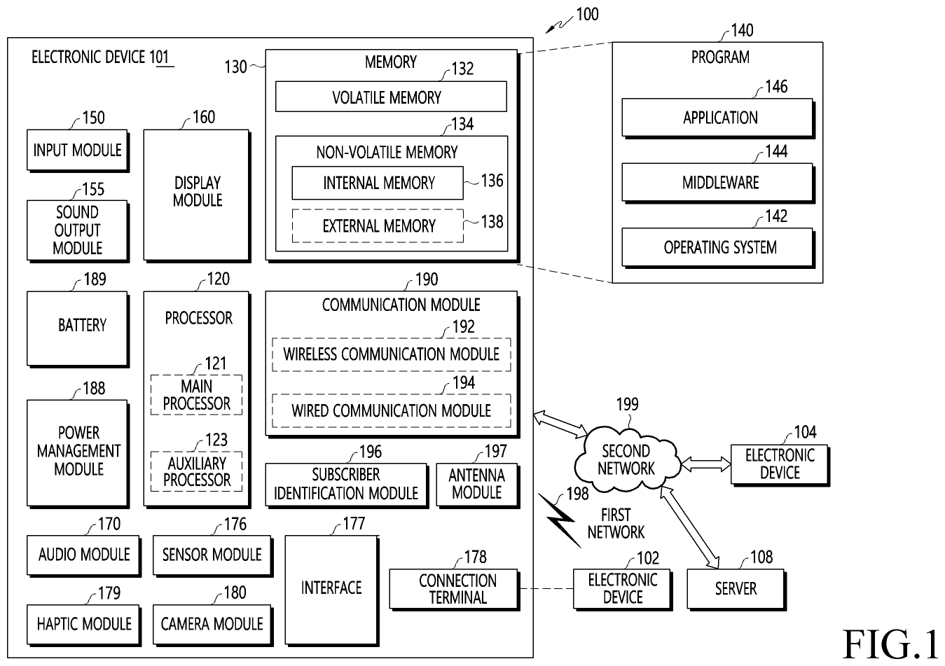

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control, for example, at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active (e.g., executing an application) state. According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence model is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or an external electronic device (e.g., an electronic device 102 (e.g., a speaker or a headphone)) directly or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna.

The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing 1 eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, an RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In an embodiment described below, an operation for decreasing a used capacity of the memory and increasing an available capacity in the state in which the available capacity of the memory is lacking may be referred to and described as a memory retrieval operation.

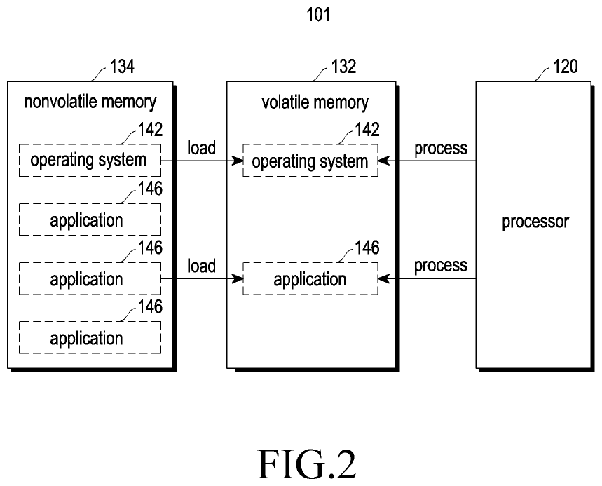

FIG. 2 illustrates an example of a configuration of an electronic device, according to an embodiment.

Referring to FIGS. 1 and 2, the processor 120 of the electronic device 101, according to an embodiment, may be electrically connected (e.g., coupled) to the memory 130 and control the operating system (or kernel) 142 and the plurality of applications 146 which are software included in the memory 130. The memory 130 may include the non-volatile memory (e.g., flash memory) 134 (e.g., flash memory) and the volatile memory 132 (e.g., random access memory (RAM)). The non-volatile memory 134 may include the operating system (or kernel) 142 and the plurality of applications 146.

According to an embodiment, the processor 120 may run the operating system (or kernel) 142 installed in the memory 130 and control the operating system (or kernel) 142 to perform a process of an application executed by the operating system (or kernel) 142.

According to an embodiment, the processor 120 may control the memory 130 such that the process executed according to the application 146 may be allocated to the memory 130. For example, the processor 120 may load the application 146 to the volatile memory (e.g., RAM) 132 from the nonvolatile memory 134. Alternatively or additionally, the processor 120 may execute the process of the application 146 that has been loaded to the volatile memory 132. The application 146 loaded to the volatile memory 132 may occupy an available capacity of the volatile memory 132 and may be executed in the operating system (or kernel) 142. The available capacity of the volatile memory 132 may be a capacity of a storage area to which no data is loaded or that is not allocated to the currently executed process. The operating system (or kernel) 142 may load the application 146 from the nonvolatile memory 134 to the volatile memory 132 and execute the application and/or allocate the process of the application 146 to the volatile memory 132 and release the allocation according to the control of the processor 120.

In some embodiments, the available capacity of the volatile memory 132 may be reduced due to repeated execution of the process and/or various processes being executed. In optional or additional embodiments, the available capacity of the volatile memory 132 may be reduced to a level where additional processes may not be executed due to lack of available capacity. In order to determine whether the available capacity of the volatile memory 132 is lacking, the processor 120 may continuously and/or periodically identify the available capacity of the volatile memory 132 and identify whether the available capacity of the volatile memory 132 is lacking on the basis of the identified available capacity. That is, the processor 120 may identify whether the available capacity of the volatile memory 132 is less than a predetermined threshold capacity. In some embodiments, the predetermined threshold capacity may be determined based on the total capacity of the volatile memory 132.

According to an embodiment, when it is identified that the available capacity of the volatile memory 132 is lacking (e.g., is less than the predetermined threshold capacity), the processor 120 may perform a memory retrieval operation for securing an available capacity of the volatile memory 132 for executing a new process. The operating system (or kernel) 142 may execute a command of performing the memory retrieval operations (e.g., at least one of a first memory operation, a second memory operation, or a third memory operation) according to the control of the processor 120.

According to an embodiment, when it is identified that the available capacity for allocating the process to the volatile memory 132 is lacking (e.g., is less than the predetermined threshold capacity), the processor 120 may be configured to perform the first memory retrieval operation for increasing the available capacity of the volatile memory 132. The first memory retrieval operation may include a first operation (e.g., kswapd (kernel swap daemon)) and a second operation (e.g., direct reclaim) for compressing and allocating some data of at least one process to an area of the volatile memory 132 or some areas of the volatile memory 132 into the nonvolatile memory 134.

According to an embodiment, the processor 120 may be configured to identify the available capacity of the volatile memory 132 on the basis of a memory pressure event generated by the first memory retrieval operation and perform at least one of the second memory retrieval operation or the third memory retrieval operation for ending at least one process allocated to the volatile memory 132. The third memory retrieval operation may retrieve the available capacity of the volatile memory 132 at a speed faster than the second memory retrieval operation. That is, a time elapsed during the performing of the second memory retrieval operation may be longer than a time elapse during the performing of the third memory retrieval operation. For example, the second memory retrieval operation may be a module or daemon (or service) (e.g., a low memory killer daemon (LMKD)) of the operating system (or kernel) 142 for securing the available capacity of the volatile memory 132, and the third memory retrieval operation may be a function (e.g., direct reclaim kill booster) performed within the LMKD.

According to an embodiment, the processor 120 may designate threshold values for the available capacity of the volatile memory 132 in order to determine whether the available capacity for allocating the process to the volatile memory 132 is lacking and determine whether to perform and stop each of the first memory retrieval operation, the second memory retrieval operation, and the third memory retrieval operation. For example, a first threshold value (low watermark×1.1) and a second threshold value (e.g., min watermark×2.0) of the specified threshold values may be designated as values to be compared with the available capacity of the volatile memory 132 in order to perform and end the second memory retrieval operation or the third memory retrieval operation. A third threshold value (e.g., low watermark), a fourth threshold value (e.g., min watermark), and a fifth threshold value (e.g., high watermark) may be designated as values to be compared with the available capacity of the volatile memory 132 in order to perform and stop the performance of the first memory retrieval operation. The first threshold value (e.g., low watermark×1.1) may be a value larger (greater) than the fifth threshold value and may be designated as a value obtained by multiplying the third threshold value by a specified value (e.g., first threshold value=third threshold value×F, where F is a value greater than 1, such as, e.g., 1.1). The second threshold value (e.g., min watermark×2.0) may be a value larger (greater) than the fourth threshold value and may be designated as a value obtained by multiplying the fourth threshold value by a specified value (e.g., first threshold value=third threshold value×G, where G is a value greater than 1, such as, e.g., 2.0). The third threshold value may be designated as a value larger (greater) than the second threshold value and smaller (less) than the fifth threshold value (e.g., fifth threshold value>third threshold value>second threshold value). The fourth threshold value may be designated as a value smaller (less) than the second threshold value (e.g., second threshold value>fourth threshold value). The fifth threshold value may be designated as a value smaller (less) than the first threshold value and larger (greater) than the third threshold value (e.g., first threshold value>fifth threshold value>third threshold value). However, the present disclosure is not limited in this regard. That is, the value of each threshold value may be changed according to the performance of the processor 120 and the nonvolatile memory 132 while the order of sizes of the threshold values (e.g., the order of sizes of first threshold value>fifth threshold value>third threshold value>second threshold value>fourth threshold value) may be maintained without any change therein.

According to an embodiment, when the available capacity of the volatile memory 132 reaches a specified threshold value (e.g., a low watermark, hereinafter referred to as the third threshold value), the processor 120 may identify that the available capacity of the volatile memory 132 to which at least one process is allocated is lacking (e.g., available capacity of the volatile memory 132 is less than or equal to the third threshold value) and may execute the first memory retrieval operation. When a value of the available capacity identified during the execution of the first memory retrieval operation exceeds a specified memory retrieval threshold value (e.g., a high watermark, hereinafter referred to as the fifth threshold value), the processor 120 may stop executing the first memory retrieval operation.

According to an embodiment, when the identified available capacity reaches the specified third threshold value (e.g., low watermark), the processor 120 may perform a first operation of the first memory retrieval operation. When the available capacity identified by a request for allocating at least one process exceeds the fifth threshold value, the processor 120 may stop the first memory retrieval operation.

According to an embodiment, when the available capacity identified during the first operation is smaller (less) than or equal to the specified fourth threshold value (e.g., min watermark), the processor 120 may perform the second memory retrieval operation. When the available capacity identified during the first memory retrieval operation exceeds the fourth threshold value, the processor 120 may stop a second memory retrieval operation of the first memory retrieval operation.

According to an embodiment, when the identified available capacity value is smaller (less) than or equal to the first threshold value (e.g., low watermark×1.1) and larger (greater) than the second threshold value (e.g., min watermark×2.0), the processor 120 may perform the second memory retrieval operation (e.g., the second memory retrieval operation in the low memory killer (LMK) or the LMKD). The processor 120 may perform the second memory retrieval operation which may include ending a selected process on the basis of process end conditions. That is, the processor 120 may select a process to be ended that satisfies the process end conditions. For example, the second memory retrieval operation may be an operation performed by a module or daemon (or service) (e.g., the LMK or the LMKD) of the operating system (or kernel) 142.

In some embodiments, the process end conditions may include a condition (e.g., a first condition) of identifying a total amount of the use of the memory (a total sum of swap memory used) and another condition (e.g., a second condition) of identifying an importance limit value (e.g., an OOM_SCORE_ADJ limit value) of the allocated process.

Alternatively or additionally, the processor 120 may stand by for a specified first delay time (e.g., 100 milliseconds (ms)) while the second memory retrieval operation is performed, select again a process to be ended, and end the selected process, and may repeatedly perform the operation of ending processes with the specified first delay time (e.g., 100 ms) until reaching the first threshold value (e.g., low watermark×1.1). The first delay time (e.g., 100 ms) may be designated such that the processes allocated to the memory may not be excessively ended.

According to an embodiment, when performing the second memory retrieval operation, the processor 120 may identify a level of an out-of-memory state according to a memory pressure event generated by the first memory retrieval operation. For example, when the identified level of the out-of-memory state is a first level (e.g., medium pressure), the processor 120 may select the most lately used (e.g., most recent) process from among at least one process having a specified importance value larger (greater) than the importance (OOM_SCORE_ADJ) limit value (e.g., a limit value of 850) as the process to be ended and process the end of the selected process.

In some embodiments, when the importance values of the at least one selected process to be ended are smaller (e.g., less) than the importance (OOM_SCORE_ADJ) limit value (e.g., 850), the processor 120 may determine not to end the at least one selected process to be ended.

In optional or additional embodiments, when the identified level of the out-of-memory state is a second level (e.g., a critical pressure), the processor 120 may identify a condition of the importance (OOM_SCORE_ADJ) limit value (e.g., a limit value of 850) and select at least one process to be ended on the basis of the process size and/or the memory occupancy. For example, the processor 120 may select at least one process having the highest importance value (e.g., process having the lowest priority and/or the highest importance) from among the processes allocated to the volatile memory 132 and/or select a process occupying the most capacity of the volatile memory 132 as the process to be ended from among the at least one selected process. The importance (OOM_SCORE_ADJ) may indicate process importance and may be determined according to a degree of exposure to a process user and then acquired along with process information. As a value is higher, the value may be preferentially selected as the process to be ended. In some embodiments, the importance (OOM_SCORE_ADJ) may have a value between −1,000 and +1,000. However, the present disclosure is not limited in this regard. That is, the importance (OOM_SCORE_ADJ) may have other value ranges without deviating from the scope of the present disclosure.

According to an embodiment, when the identified value of available capacity is smaller (less) than or equal to a first threshold value and smaller (less) than or equal to a second threshold value, the processor 120 may process execution of the third memory retrieval operation (e.g., direct reclaim kill booster). The processor 120 may select at least one process having the highest importance value from among the processes allocated to the volatile memory 132 without identifying process end conditions (e.g., the first condition and/or the second condition) and select a process occupying the most capacity of the volatile memory 132 as the process to be ended from among the at least one selected process. The processor 120 may process execution of the third memory retrieval operation of ending the selected process. For example, the third memory retrieval operation may include an operation (e.g., direct reclaim kill booster) by the module or daemon (or service) (e.g., the LMK or the LMKD) of the operating system (or kernel) 142.

In some embodiments, the processor 120 may stand by for a specified second delay time (e.g., 20 ms) while the third memory retrieval operation is performed, select again a process to be ended, end the newly selected process to be ended, and may repeatedly perform the operation of ending the process with the specified second delay time (e.g., 20 ms) until reaching the second threshold value (e.g., min watermark×2.0). However, the present disclosure is not limited thereto, and the second delay time may be configured as a time shorter than the first delay time (e.g., 100 ms) and, when the first delay time becomes shorter, may be designated to be shorter in proportion thereto.

According to an embodiment, when the value of the available capacity identified during the third memory retrieval operation is larger (e.g., greater) than the second threshold value, the processor 120 may stop the third memory retrieval operation. The processor 120 may secure the available capacity of the memory faster by the third memory retrieval operation by processing execution of the third memory retrieval operation before the second operation and reduce the operation time by the second operation.

As described above, according to various embodiments of the present disclosure, main elements of the electronic device 101 have been described through the electronic device 101 of FIG. 2. However, according to various embodiments of the present disclosure, not all of the elements illustrated in FIG. 2 are necessary elements, and the electronic device 101 may be implemented using more or less elements than the illustrated elements. Further, locations of the main elements of the electronic device 101 illustrated in FIG. 2 may vary in various embodiments.

According to an embodiment, an electronic device (e.g., the electronic device 101 of FIGS. 1 and 2) may include a memory 130, and at least one processor 120 electrically connected (e.g., coupled) to the memory 130, wherein the memory 130 stores instructions configured to, when executed by the at least one processor 120, cause the electronic device to retrieve some data of at least one process allocated to the memory and perform a first memory retrieval operation for increasing an available capacity of the memory based on identifying that the available capacity for allocating a process to the memory is lacking, identify the available capacity of the memory, based on an event generated by the first memory retrieval operation, perform a second memory retrieval operation, based on a value of the identified available capacity being smaller (less) than or equal to a first threshold value and larger (greater) than a second threshold value, and perform a third memory retrieval operation, based on a value of the identified available capacity being smaller (less) than or equal to the first threshold value and smaller (less) than or equal to the second threshold value, and the first threshold value is a value larger (greater) than the second threshold value.

According to an embodiment, the third memory retrial operation may secure the available capacity of the memory 130 faster than the second memory retrieval operation.

According to an embodiment, the memory 130 stores instructions configured to cause the electronic device to end a process selected from among the at least one allocated process, stand by for a specified delay time, and perform an operation of a next selected process while the third memory retrieval operation is performed, and the specified delay time may be designated as a time shorter than a specified delay time in the second memory retrieval operation.

According to an embodiment, the memory 130 stores instructions configured to cause the electronic device to stop the third memory retrieval operation when the available capacity identified during the third memory retrieval operation is larger (greater) than the second threshold value and stop the second memory retrieval operation when the available capacity identified during the second memory retrieval operation is larger (greater) than the first threshold value.

According to an embodiment, the memory 130 stores instructions configured to cause the electronic device to identify that the identified available capacity is lacking and perform the first memory retrieval operation when the identified available capacity according to a request for allocating a process reaches a specified third threshold value, perform the third memory retrieval operation before a second operation, and the first memory retrieval operation may include a first operation and the second operation for retrieving some data of the at least one process allocated to an area of the memory.

According to an embodiment, the memory 130 stores instructions configured to cause the electronic device to perform the first operation when the identified available capacity according to the request for allocating the process is smaller (less) than or equal to a specified third threshold value (e.g., low watermark), perform the second operation when the available capacity identified during the first operation is smaller (less) than or equal to a specified fourth threshold value (e.g., min watermark), stop the first operation when the available capacity identified during the first operation is larger (greater) than a fifth threshold value, and stop the second operation when the available capacity identified during the second operation is larger (greater) than the fourth threshold value, the third threshold value may be a value larger (greater) than the second threshold value, and the fourth threshold may be a value smaller (less) than the second threshold value.

According to an embodiment, the memory 130 stores instructions configured to cause the electronic device to perform the third memory retrieval operation before the second operation.

According to an embodiment, the memory 130 stores instructions configured to cause the electronic device to, when the third memory retrieval operation is performed, select at least one process to be ended from among processes allocated to the memory, based on at least one of a process size or a memory occupancy, and an importance value, and end the at least one selected process to be ended without identifying a specified process end condition.

According to an embodiment, the memory 130 stores instructions configured to cause the electronic device to, when the second memory retrieval operation is performed, select at least one process to be ended from among the processes allocated to the memory, based on a specified process end condition and specified importance, and end the at least one selected process to be ended.

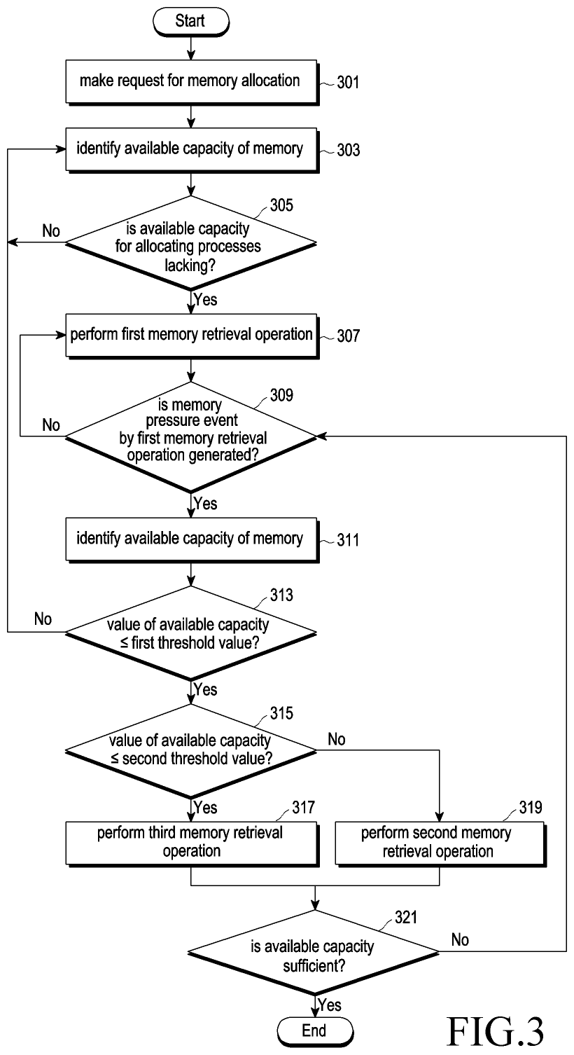

FIG. 3 illustrates an example of a method of operating an electronic device according to an embodiment. The operation method according to an embodiment may be performed by a processor (e.g., the processor 120) controlling an operating system (or kernel) (e.g., the operating system 142 of FIG. 1) which is a software component installed in an electronic device (e.g., the electronic device 101 of FIGS. 1 and 2).

Referring to FIG. 3, the electronic device 101, according to an embodiment, may identify a memory allocation request in operation 301. In operation 303, the electronic device 101 may identify the current available capacity of a memory (e.g., the volatile memory 132 of FIGS. 1 and 2) for allocating a process in the memory 132, in response to the memory allocation request. For example, the electronic device 101 may identify the available capacity by checking a total amount of the memory 132 used by the processes allocated to the memory 132.

In operation 305, the electronic device 101 may identify whether the identified available capacity is too small to allocate a process. When the available capacity is not enough to allocate the process as a result of the identification, operation 307 may be performed (Yes at operation 305). Otherwise, operation 303 may be performed (No at operation 305).

In operation 307, the electronic device 101 may perform the first memory retrieval operation to increase the available capacity of the memory 132. The first memory retrieval operation may be an operation executed by at least one module of the operating system (or kernel) (e.g., the operating system 142 of FIGS. 1 and 2) for securing the available capacity of the memory 132 configured as an embedded system. The electronic device 101 may execute the first memory retrieval operation until sufficient available capacity is secured to allocate a process and continuously secure the available capacity of the memory 132. For example, the electronic device 101 may compress some data of at least one process allocated to the memory 132 by performing the first memory retrieval operation and store some of the compressed processes in some areas of the memory 132, and then load and use the same as necessary. For example, the first memory retrieval operation may include a first operation (e.g., kswapd) and a second operation (e.g., direct reclaim) for securing available capacity by compressing some of at least one process allocated to the memory 132 or converting cached capacity (e.g., cachedmem) into available capacity. The first memory retrieval operation has larger operation load and has a high priority of a calculation processing operation by a CPU (e.g., main processor 121 of FIG. 1).

In operation 309, the electronic device 101 may identify whether a memory pressure event is generated by the first memory retrieval operation. When the memory pressure event is generated as a result of the identification, the electronic device 101 may perform operation 311 (Yes at operation 309) and, otherwise, perform operation 307 (No at operation 309).

In operation 311 to operation 321, the electronic device 101 may identify the current available capacity of the memory 132, end at least one other process allocated to the memory 132, and repeatedly perform at least one of the second memory retrieval operation or the third memory retrieval operation for securing available capacity of the memory 132 until the available capacity of the memory 132 reaches a sufficient state. The second memory retrieval operation or the third memory retrieval operation may secure available capacity of the memory faster than the first memory retrieval operation.

In operation 311, the electronic device 101 may identify the available capacity of the memory 132 in response to identification of the generation of the memory pressure event by the first memory retrieval operation.

In operation 313, the electronic device 101 may identify whether the identified available capacity value is smaller (less) than or equal to a first threshold value. When the identified available capacity is smaller (less) than or equal to the first threshold value as a result of the identification, the electronic device 101 may perform operation 315 (Yes at operation 313) and, otherwise, perform operation 303 (No at operation 313).

In operation 315, the electronic device 101 may identify whether the identified available capacity value is smaller (less) than or equal to a specified second threshold value (e.g., min watermark×2.0). The electronic device 101 may perform operation 317 when the identified available capacity is larger (greater) than the specified second threshold value as a result of the identification, and may perform operation 319 when the identified available capacity is smaller (less) than or equal to the specified second threshold value. The first threshold value may be designated as a value larger (greater) than the second threshold value.

In operation 317, the electronic device 101 may perform the third memory retrieval operation for securing available capacity by ending at least one process allocated to the memory 132. The electronic device 101 may secure the available capacity by ending at least one process allocated to the configured memory 132 on the basis of information related to process priority. The electronic device 101 may directly select a process to be ended and end the selected process to be ended without an operation of identifying process end conditions. The electronic device 101 may perform the third memory retrieval operation until reaching the specified second threshold value. For example, the third memory retrieval operation may be an operation (e.g., direct reclaim kill booster) by the module or daemon (or service) (e.g., the LMK or the LMKD) of the operating system (or kernel) for securing available capacity of the memory 132.

In operation 319, the electronic device 101 may perform the second memory retrieval operation for securing available capacity by ending at least one process allocated to the memory. The electronic device 101 may secure the available capacity by ending at least one process allocated to the memory 132 on the basis of information related to process priority according to the first memory retrieval operation. The electronic device 101 may perform the second memory retrieval operation until reaching the specified first threshold value on the basis of process end conditions. For example, the second memory retrieval operation may be an operation by the module (e.g., LMN) or demon (or service) (e.g., LMKD) of the operating system for securing available capacity of the memory 132. For example, the process end conditions may include a condition (e.g., a first condition) of identifying a total amount of the use of the memory 132 (e.g., a total sum of swapused) and another condition (e.g., a second condition) of identifying an importance limit value (e.g., ADJ limit value) of the allocated process.

In operation 321, the electronic device 101 may identify whether the secured available capacity is sufficient. The electronic device 101 may end the operation when the secured available capacity is sufficient as a result of the identification (Yes at operation 321), and may perform operation 309 again when the secured available capacity is not sufficient (No at operation 321).

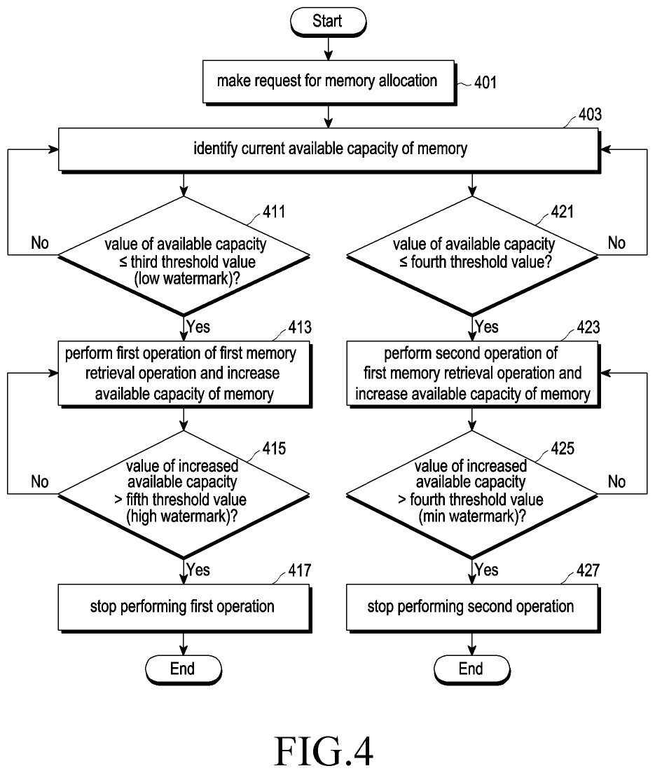

FIG. 4 illustrates an example of the operation method by the first memory retrieval operation of the electronic device, according to an embodiment.

Referring to FIG. 4, an electronic device (e.g., the electronic device 101 of FIGS. 1 and 2), according to an embodiment, may identify a memory allocation request in operation 401. For example, when receiving a process execution command of an application, the electronic device 101 may identify the memory allocation request according to process execution and execute a memory allocation-related function of an operating system (or kernel) (e.g., the operating system 142 of FIGS. 1 and 2).

In operation 403, the electronic device 101 may secure the current available capacity of a memory (e.g., the volatile memory 132 of FIGS. 1 and 2) in response to the memory allocation request. For example, the electronic device 101 may attempt allocation of the corresponding process to the memory 132 through the memory allocation-related function and identify the current available capacity of the memory 132.

The electronic device 101 may perform operation 411 or operation 421 in order to identify whether the identified available capacity is enough to allocate the corresponding process.

After operation 403, the electronic device 101 may identify whether the identified available capacity value is smaller (less) than or equal to a specified third threshold value (e.g., low watermark) in operation 411. When the identified available capacity value is smaller (less) than or equal to the specified third value as a result of the identification, the electronic device 101 may perform operation 413 (Yes at operation 411) and, otherwise, perform operation 403 again (No at operation 411).

In operation 413, the electronic device 101 may increase the available capacity of the memory 132 by performing a first operation (e.g., kswapd) of the first memory retrieval operation.

In operation 415, the electronic device 101 may identify whether the increased available capacity value is larger (greater) than a fifth threshold value indicating a specified memory retrieval threshold value (e.g., high watermark). When the increased available capacity value is larger (greater) than the specified fifth threshold value on the basis of the result of identification in operation 415, the electronic device 101 may identify that the available capacity of the memory 132 is sufficient and end the operation after stopping execution of the first operation in operation 417 (Yes at operation 415). Otherwise, when the increased available capacity value is not larger (greater) than the specified fifth threshold value on the basis of the result of identification in operation 415, the electronic device 101 may repeatedly perform operation 413 again (No at operation 415).

After operation 403, the electronic device 101 may identify whether the identified available capacity value is smaller (less) than or equal to a specified fourth threshold value (e.g., min watermark) in operation 421. The electronic device 101 may perform operation 423 when the identified available capacity value is smaller (less) than or equal to the fourth threshold value on the basis of the identification result (Yes at operation 421) and, otherwise, perform operation 403 (No at operation 421) again.

In operation 423, the electronic device 101 may increase the available capacity of the memory 132 by performing a second operation (e.g., direct reclaim) of the first memory retrieval operation.

In operation 425, the electronic device 101 may identify whether the increased available capacity value is larger (greater) than the fourth threshold value. When the increased available capacity value is larger (greater) than the specified fourth threshold value on the basis of the result of identification in operation 415, the electronic device 101 may identify that the available capacity of the memory 132 is sufficient and end the operation after stopping execution of the second operation in operation 417 (Yes at operation 425). Otherwise, when the increased available capacity value is not larger (greater) than the specified fourth threshold value on the basis of the result of identification in operation 415, the electronic device 101 may repeatedly perform operation 423 again (No at operation 425).

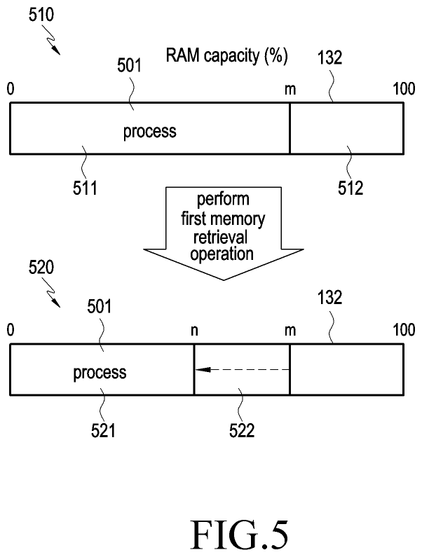

FIG. 5 illustrates an example of the first memory retrieval operation of the electronic device, according to an embodiment.

Referring to FIG. 5, an electronic device (e.g., the electronic device 101 of FIGS. 1 and 2), according to an embodiment, may identify a capacity (e.g., a section from 0% to m %) occupied by a process 501 in the total capacity (e.g., 100%) of the memory 132 (e.g., the volatile memory 132 of FIGS. 1 and 2) before the memory retrieval operation as a used capacity 511 and identify the remaining capacity (e.g., a section from m % to 100% or 100%−m %) except for the identified used capacity as an available capacity 512 as shown in a bar graph in operation 510.

After performing the first memory retrieval operation (e.g., the first operation or the second operation) in operation 307 of FIG. 3 and operation 413 or operation 423 of FIG. 4, the electronic device 101 may maintain main data 521 among the data of the process 501 and retrieve additional data 522 from the memory 132 as shown in a bar graph in operation 520. The electronic device 101 may compress the retrieved additional data 522 and store the same in some areas of the memory 132 or some areas configured as a virtual memory in the volatile memory 132. The electronic device 101 may retrieve an available capacity corresponding to the capacity (e.g., a section from n % to m % or m %−n %) occupied by the additional data 522 and secure the available capacity (e.g., 100%−n %). For example, main data of the process 501 may be core data required for executing the process 501 as data having high importance, and the additional data of the process 501 may be cache data or metadata which may or may not be used selectively used for the execution of the process 501 as data having low importance.

The bar graphs in operation 510 and operation 520 of FIG. 5 show an example in which one process 501 is allocated to the section (e.g., section from 0% to m %) indicating the available capacity of the memory 132 for convenience of description, but are not limited thereto and a plurality of processes may be allocated to the section (e.g., section from 0% to m %) indicating the available capacity of the memory 132.

According to an embodiment, in comparison between the first memory retrieval operation and the second memory retrieval operation and/or the third memory retrieval operation, the first memory retrieval operation may have large load of the processor, a slow memory retrieval speed, high memory retrieval efficiency, and relatively high responsibility when the process is rebooted after memory retrieval.

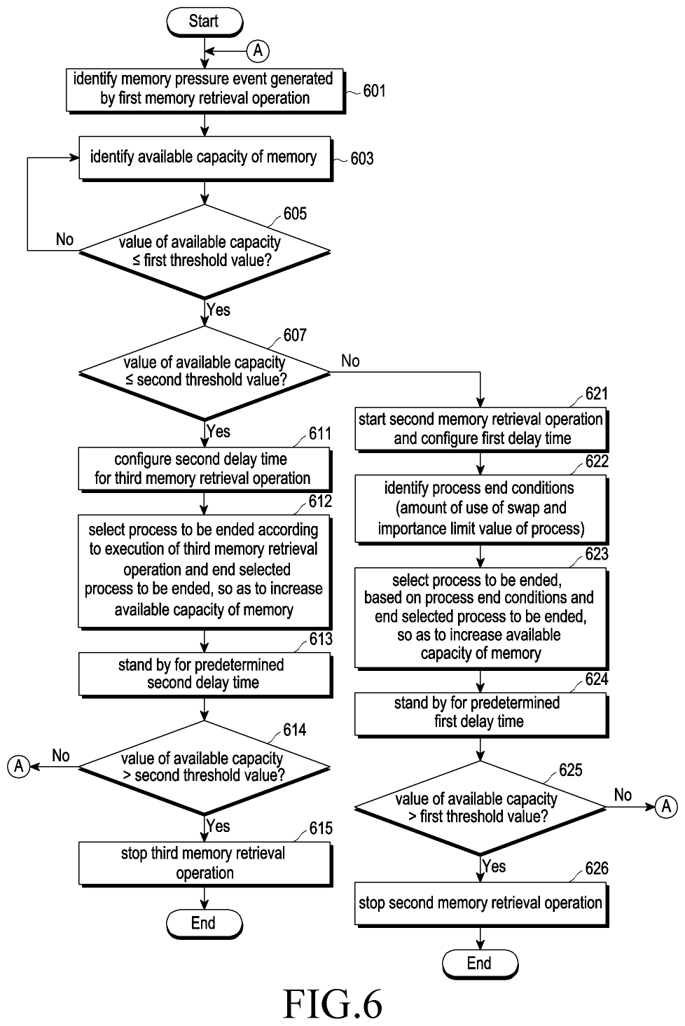

FIG. 6 illustrates an example of the operation method by the second and third memory retrieval operations of the electronic device according to an embodiment.

Referring to FIG. 6, an electronic device (e.g., the electronic device 101 of FIGS. 1 and 2), according to an embodiment, may start executing a memory retrieval operation (e.g., the second memory retrieval operation and/or the third memory retrieval operation) for ending a process allocated to the memory 132 (e.g., the memory 132 of FIGS. 1 and 2) according to identification of generation of a memory pressure event by the first memory retrieval operation in operation 601.

In operation 603, the electronic device 101 may identify the current available capacity of the memory 132.

In operation 605, the electronic device 101 may identify whether the identified available capacity is smaller (less) than or equal to a first threshold value. When the identified available capacity value is smaller (less) than or equal to a first threshold value on the basis of the identification result, the electronic device 101 may perform operation 607 (Yes at operation 605) and, otherwise, may perform operation 603 again (No at operation 605).

In operation 607, the electronic device 101 may identify whether the identified available capacity is smaller (less) than or equal to a second threshold value (e.g., min watermark×2.0). The electronic device 101 may perform operation 611 when the identified available capacity value is smaller (less) than or equal to the specified second threshold value on the basis of the identification result (Yes at operation 607), and perform operation 621 when the identified available capacity value is larger (greater) than the specified second threshold value (No at operation 607). The first threshold value may be designated as a value larger (greater) than the second threshold value.

In operation 611, the electronic device 101 may configure a second delay time (e.g., 20 ms) for the third memory retrieval operation and start executing the third memory retrieval operation for ending at least one process on the basis of the configured second delay time according to identification that the available capacity value is smaller (less) than or equal to the first threshold value and smaller (less) than or equal to the second threshold value (e.g., min watermark×2.0). The second delay time (e.g., 20 ms) may be configured as a value smaller (less) than the first delay time (e.g., 100 ms).

In operation 612, the electronic device 101 may select a process to be ended from among at least one process allocated to the memory 132 according to execution of the third memory retrieval operation and end the selected process to be ended, so as to increase the available capacity of the memory 132. The electronic device 101 may directly select the process to be ended and end the selected process to be ended without an operation of identifying process end conditions. For example, the electronic device 101 may select a process having low priority (or having high importance) and occupying the largest capacity (or having the largest process size) as the process to be ended on the basis of information related to process priority.

In operation 613, the electronic device 101 may stand by for the specified second delay time without performing the operation of ending the process and identify the available capacity of the memory 132 according to the third memory retrieval operation.

In operation 614, the electronic device 101 may identify whether the identified available capacity value is larger (greater) than a second threshold value.

When the identified available capacity value is larger (greater) than the second threshold value on the basis of the result of identification in operation 614, the electronic device 101 may identify that the identified available capacity value is larger (greater) than the second threshold value and thus the available capacity of the memory 132 is sufficient (Yes at operation 614), stop the third memory retrieval operation (e.g., enter a wait state) in operation 615, and then end the operation.

When the identified available capacity value is smaller (less) than or equal to the second threshold value on the basis of the result of identification in operation 614 (No at operation 614), the electronic device 101 may perform operation 601 again. For example, the third memory retrieval operation may be an operation (e.g., direct reclaim kill booster) by the module or daemon (or service) (e.g., the LMK or the LMKD) of the operating system (or kernel) for securing available capacity of the memory 132.

When the available capacity value is larger (greater) than the specified second threshold value on the basis of the result of identification in operation 607, the electronic device 101 may configure the first delay time (e.g., 100 ms) for the second memory retrieval operation and start executing the second memory retrieval operation for ending at least one process on the basis of the configured first delay time according to identification that the available capacity value is smaller (less) than or equal to the specified first threshold value and is larger (greater) than the second threshold value (e.g., min watermark×2.0) in operation 621.

In operation 622, the electronic device 101 may identify process end conditions of at least one process allocated to the memory 132 according to execution of the second memory retrieval operation. For example, the process end conditions may include a condition (e.g., a first condition) of identifying a total amount of the use of the memory 132 (e.g., a total sum of swapused) and a condition (e.g., a second condition) of identifying an importance limit value (e.g., ADJ limit value) of the allocated process.

In operation 623, the electronic device 101 may select a process to be ended on the basis of the identified process end conditions and end the selected process to be ended. The electronic device 101 may select at least one process to be ended, which satisfies the process end conditions, and end the selected process to be ended on the basis of information related to process priority among the at least one selected process to be ended. When a level of the out-of-memory state is a first level (e.g., medium pressure), the electronic device 101 may end the last used process. Alternatively or additionally, when the level of the out-of-memory state is a second level (e.g., critical level), the electronic device 101 may end a process having the lowest priority (or having the highest importance) and occupying the largest capacity (e.g., having the largest process size).

In operation 624, the electronic device 101 may stand by for the specified first delay time without performing the operation of ending the process and identify the available capacity of the memory 132 according to the second memory retrieval operation.

In operation 625, the electronic device 101 may identify whether the identified available capacity value is larger (greater) than the first threshold value.

When the identified available capacity value is larger (greater) than the first threshold value on the basis of the result of identification in operation 625, the electronic device 101 may identify that the identified available capacity is larger (greater) than the first threshold value and thus the available capacity of the memory 132 is sufficient (Yes at operation 625) and stop the second memory retrieval operation (e.g., enter a wait state) in operation 626.

When the identified available capacity value is smaller (less) than or equal to the first threshold value on the basis of the result of identification in operation 625, the electronic device 101 may perform operation 622 again (No at operation 625). The electronic device 101 may repeatedly perform operation 622 to operation 625 until reaching the specified first threshold value. For example, the second memory retrieval operation may be an operation (e.g., direct reclaim kill booster) by the module or daemon (or service) (e.g., the LMK or the LMKD) of the operating system (or kernel) for securing available capacity of the memory.

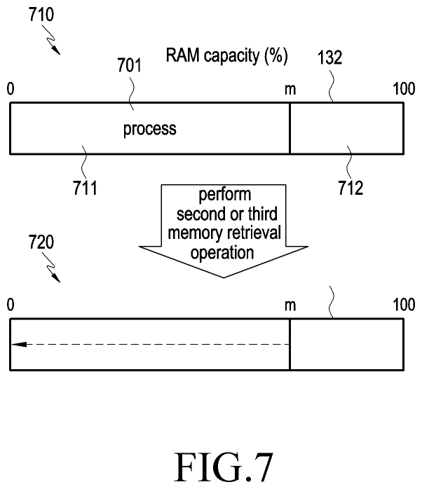

FIG. 7 illustrates an example of the second and third memory retrieval operations of the electronic device according to an embodiment.

Referring to FIG. 7, an electronic device (e.g., the electronic device 101 of FIGS. 1 and 2) may identify a capacity (e.g., a capacity from 0% to m %) occupied by a process 701 in the total capacity (e.g., 100%) of the memory 132 (e.g., the volatile memory 132 of FIGS. 1 and 2) before the memory retrieval operation as a used capacity 711 and identify the remaining capacity (e.g., m % to 100%) except for the identified used capacity as an available capacity 712 as shown in a bar graph in operation 710. After performing the second memory retrieval operation or the third retrieval memory operation in operation 337 or operation 319 of FIG. 3 and operation 612 or operation 623 of FIG. 6, the electronic device 101 may end the selected process 701 among processes allocated to the memory 132 to secure the most capacity (e.g., 0% to m %) occupied by the process 701 as the available capacity as shown in a bar graph in operation 720.

The bar graphs in operation 710 and operation 720 of FIG. 7 show an example in which one process 701 is allocated to a section (e.g., section from 0% to m %) indicating the used capacity of the memory 132 for convenience of description but are not limited thereto. Allocation of a plurality of processes to the section (section from 0 to m) indicating the used capacity of the memory 132 in the bar graph of operation 720 of FIG. 7 may be described by way of example, in which case the most capacity occupied by at least one selected process may be secured as the available capacity.

According to an embodiment, the second memory retrieval operation and the third memory retrieval operation retrieve all data of the selected process according to importance without distinction between main data and additional data among the data of the process loaded to the memory, and thus may have smaller load of the processor compared to the first memory retrieval operation and a faster memory retrieval speed compared to the first memory retrieval operation. The second memory retrieval operation and/or the third memory retrieval operation may have small load of the processor, a fast memory retrieval speed, low memory retrieval efficiency, and relatively low responsibility when the process is rebooted after memory retrieval.

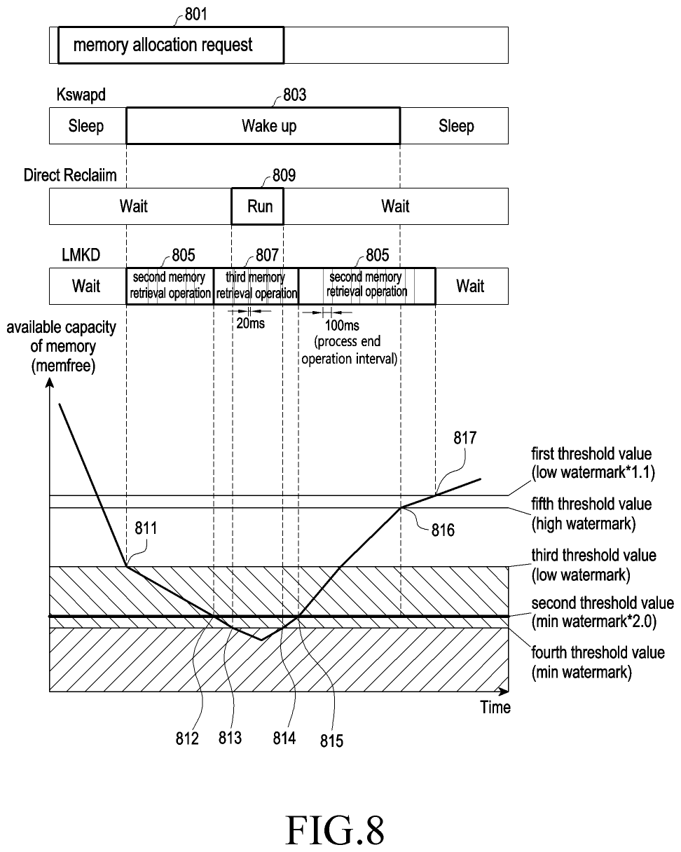

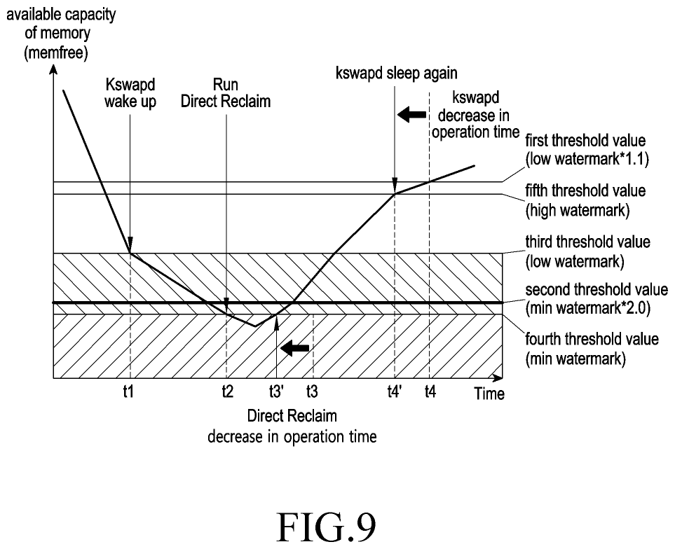

FIG. 8 illustrates an example of the operation of the electronic device according to an embodiment, and FIG. 9 illustrates an example of an operation graphs based on the operation of the electronic device according to an embodiment.

Referring to FIG. 8, the electronic device 101 according to an embodiment may enter an operation state for retrieving an available capacity of a memory (e.g., the volatile memory 132 of FIGS. 1 and 2) and identify the available capacity of the memory 132 according to identification of generation of a memory allocation request 801. At this time, memory retrieval operations (a first memory retrieval operation, a second memory retrieval operation, and a third memory retrieval operation) may be in a sleep state or a wait state.

When the identified available capacity reaches a third threshold value (e.g., low watermark), the electronic device 101 may start (wake up) a first operation (e.g., kswapd) 803 of the first memory retrieval operation at a first time point 811 in operation 413 of FIG. 4. The electronic device 101 may execute a memory retrieval operation (e.g., at least one of a second memory retrieval operation 805 or the third memory retrieval operation 807) for ending a process allocated to the memory 132 according to identification of a memory pressure event generated by the first memory retrieval operation.

According to an embodiment, when the identified available capacity becomes lower (less) than or equal to the third threshold value (e.g., low watermark) as time goes by after performing the first operation 803, the electronic device 101 may perform the second memory retrieval operation 805 like in operation 319 of FIG. 3 and operation 621 to operation 626 of FIG. 6. For example, the second memory retrieval operation 805 may be started at a first time point 811, and may end the selected process to be ended again after standing by for a specified delay time (e.g., 100 ms) and repeatedly perform the operation of ending the process with the specified delay time (e.g., 100 ms) until reaching the first threshold value (e.g., low watermark×1.1).

According to an embodiment, when the identified available capacity becomes lower (less) than or equal to the second threshold value (e.g., min watermark×2.0) as time goes by after executing the first operation 803, the electronic device 101 may perform the third memory retrieval operation 807 like in operation 317 of FIG. 3 and operation 611 to operation 615 of FIG. 6. For example, the third memory retrieval operation 807 may be started at a second time point 812 when the available capacity identified during execution of the second memory retrieval operation 805 is smaller (less) than or equal to the second threshold value (e.g., min watermark×2.0). For another example, the third memory retrieval operation 807 may be started at the second time point 812 when a memory pressure event generated by the first operation 803 is identified and it is identified that the available capacity is smaller (less) than or equal to the second threshold value. Alternatively or additionally, the third memory retrieval operation 807 may end the selected process to be ended again after standing by for a specified delay time (e.g., 20 ms) and repeatedly perform the operation of ending the process with the specified delay time (e.g., 20 ms) until reaching the second threshold value (e.g., min watermark×2.0).

According to an embodiment, the electronic device 101 may start the second operation 809 at a third time point 813 when the available capacity identified during execution of the first operation 803 reaches a fourth threshold value (e.g., min watermark) and may stop the second operation and enter a wait state at a fourth time point 814 when the available capacity is larger (greater) than the fourth threshold value.

According to an embodiment, when the identified available capacity becomes larger (greater) than the second threshold value as time goes by after executing the third memory retrieval operation 803, the electronic device 101 may start again the second memory retrieval operation 805 at a fifth time point 815 and repeatedly perform the operation of ending the process with the specified delay time (e.g., 100 ms) until reaching the first threshold value (e.g., low watermark×1.1). When the identified available capacity is larger (greater) than the first threshold value (e.g., low watermark×1.1), the electronic device 101 may determine that the available capacity is sufficient, stop the second memory retrieval operation 805 at a seventh time point 817, and then enter a wait state.

According to an embodiment, when the available capacity identified during execution of the first operation 805 is larger (greater) than a fifth threshold value (high watermark), the electronic device 101 may stop the first operation 805 and enter a sleep state at a sixth time point.

As illustrated in FIG. 8, according to an embodiment, the first threshold value (e.g., low watermark×1.1) is a value larger (greater) than the fifth threshold value and may be designated as a value larger (greater) than the third threshold value through the product of the third threshold value and a specified value. The second threshold value (e.g., min watermark×2.0) is a value larger (greater) than the fourth threshold value and may be designated as a value obtained by multiplying the fourth threshold value by a specified value, the value being larger (greater) than the fourth threshold value. The third threshold value may be designated as a value larger (greater) than the second threshold value and smaller (less) than the fifth threshold value. The fourth threshold value may be designated as a value smaller (less) than the second threshold value. The fifth threshold value may be a designated as a value smaller (less) than the first threshold value and larger (greater) than the third threshold value. The specified threshold described according to an embodiment are not limited thereto, and the value of each threshold value may be changed according to the performance of the processor 120 and the nonvolatile memory 132 while the order of sizes of the threshold values (e.g., the order of sizes of first threshold value>fifth threshold value>third threshold value>second threshold value>fourth threshold value) is maintained without any change therein.

Referring to FIGS. 8 and 9, the second operation (e.g., direct reclaim) of the first memory retrieval operation may be stopped at t3 and the first operation (e.g., kswapd) may be stopped at t4 through the performance of the first memory retrieval operation and the second memory retrieval operation on the basis of comparison only between the third threshold value and the fourth threshold value of the available capacity of the memory. According to an embodiment, it may be possible to reduce the operation time of the second operation (e.g., direct reclaim) from t3 to t3′ by performing the third memory retrieval operation 807 after further comparing the second threshold value of the available capacity of the memory 132 to secure the available capacity of the memory 132 faster than the second memory retrieval operation and reduce the operation time of the first operation (e.g., kswapd) from t4 to t4′ according to the reduction in the operation time of the second operation. According to an embodiment, when the available capacity is lacking during the first memory retrieval operation, the electronic device 101 may reduce the load of a processor (e.g., the processor 120 of FIGS. 1 and 2) according to execution of the first memory retrieval operation (first operation and/or second operation).

According to an embodiment, an operation method of an electronic device 101 may include an operation of, based on identifying that an available capacity for allocating a process to a memory 132 of the electronic device 101 is lacking, retrieving some data of at least one process allocated to the memory 132 and performing a first memory retrieval operation for increasing an available capacity of the memory, an operation of identifying the available capacity of the memory, based on an event generated by the first memory retrieval operation, an operation of performing a second memory retrieval operation, based on a value of the identified available capacity smaller (less) than or equal to a first threshold value and larger (greater) than a second threshold value, and an operation of performing a third memory retrieval operation, based on a value of the identified available capacity smaller (less) than or equal to the first threshold value and smaller (less) than or equal to the second threshold value. The first threshold value may be a value larger (greater) than the second threshold value.

According to an embodiment, the third memory retrial operation may secure the available capacity of the memory 132 faster than the second memory retrieval operation.

According to an embodiment, the operation of performing the third memory retrieval operation may include an operation of ending a process selected from among the at least one allocated process while the third memory retrieval operation is performed, an operation of standing by for a specified delay time, and an operation of ending a next selected process, and the specified delay time may be designated as a time shorter than a specified delay time in the second memory retrieval operation.

According to an embodiment, the method may further include an operation of stopping the third memory retrieval operation when the available capacity identified during the third memory retrieval operation is larger (greater) than the second threshold value and an operation of stopping the second memory retrieval operation when the available capacity identified during the second memory retrieval operation is larger (greater) than the first threshold value.

According to an embodiment, the operation of performing the first memory retrieval operation may include an operation of identifying that the identified available capacity is lacking when the identified available capacity according to a request for allocating a process reaches a specified third threshold value.

According to an embodiment, the first memory retrieval operation may include a first operation and the second operation for retrieving some data of the at least one process allocated to an area of the memory.

According to an embodiment, the operation of performing the first memory retrieval operation may include an operation of performing the first operation when the identified available capacity according to the request for allocating the process is smaller (less) than or equal to a specified third threshold value, an operation of performing the second operation when the available capacity identified during the first operation is smaller (less) than or equal to a specified fourth threshold value (min watermark), an operation of stopping the first operation when the available capacity identified during the first operation is larger (greater) than a fifth threshold value, and an operation of stopping the second operation when the available capacity identified during the second operation is larger (greater) than the fourth threshold value. The third threshold value may be a value larger (greater) than the second threshold value, and the fourth threshold value may be a value smaller (less) than the second threshold value.

According to an embodiment, the third memory retrieval operation may be performed before the second operation.

According to an embodiment, the operation of performing the third memory retrieval operation may include an operation of selecting at least one process to be ended from among processes allocated to the memory, based on at least one of a process size or a memory occupancy, and an importance value, and an operation of ending the at least one selected process to be ended without identifying a specified process end condition.

According to an embodiment, the operation of performing the second memory retrieval operation may include an operation of selecting at least one process to be ended from among the processes allocated to the memory, based on a specified process end condition, an operation of selecting at least one process to be ended from among the processes allocated to the memory 132 from among the at least one selected process, based on specified importance, and an operation of ending the at least one selected process to be ended.

A computer-readable storage medium may include a hard disk, a floppy disk, magnetic media (e.g., a magnetic tape), optical media (e.g., a compact disc read only memory (CD-ROM) and a digital versatile disc (DVD)), magneto-optical media (e.g., a floptical disk), a hardware device (e.g., a read only memory (ROM), a random access memory (RAM), a flash memory), and the like. In addition, the program instructions may include high class language codes, which may be executed in a computer by using an interpreter, as well as machine codes made by a compiler. The hardware device may operate as one or more software modules to perform the operation according to various embodiments, and vice versa.

According to an embodiment, a non-transitory computer-readable storage medium storing programs, the programs comprising executable instructions configured to, when executed by a processor of an electronic device, cause the electronic device to, based on identifying that an available capacity for allocating a process to a memory 132 of the electronic device 101 is lacking, retrieve some data of at least one process allocated to the memory 132 and perform a first memory retrieval operation for increasing an available capacity of the memory, identify the available capacity of the memory, based on an event generated by the first memory retrieval operation, perform a second memory retrieval operation, based on a value of the identified available capacity smaller (less) than or equal to a first threshold value and larger (greater) than a second threshold value, and perform a third memory retrieval operation, based on a value of the identified available capacity smaller (less) than or equal to the first threshold value and smaller (less) than or equal to the second threshold value, and the first threshold value is a value larger (greater) than the second threshold value.

Embodiments disclosed in this document are presented for explanation and understanding of the disclosed technology, and do not limit the scope of the technology disclosed in this document. Accordingly, the scope of this document should be construed to include all modifications based on the technical idea of this document or various other embodiments.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B”, “at least one of A and B”, “at least one of A or B”, “A, B, or C”, “at least one of A, B, and C”, and “at least one of A, B, or C”, may include any one of, or all possible combinations of the items enumerated together in a corresponding one of the phrases. As used herein, such terms as “1st” and “2nd”, or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with”, “coupled to”, “connected with”, or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic”, “logic block”, “part”, or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device, comprising:
a memory; and
at least one processor electrically coupled to the memory,
wherein the memory stores instructions configured to, when executed by the at least one processor, cause the electronic device to:
based on identifying that a first available capacity of the memory for allocating a process to the memory is less than a capacity threshold, retrieve data of at least one process allocated to the memory and perform a first memory retrieval operation for increasing the first available capacity of the memory;
identify an available capacity of the memory, based on an event generated by the first memory retrieval operation,
perform a second memory retrieval operation, based on a value of the identified available capacity being less than or equal to a first threshold value and the identified available capacity being greater than a second threshold value; and
perform a third memory retrieval operation, based on a value of the identified available capacity being less than or equal to the first threshold value and the identified available capacity being less than or equal to the second threshold value,
wherein the first threshold value is greater than the second threshold value.

2. The electronic device of claim 1, wherein the memory stores instructions configured to cause the electronic device to:
end a first process selected from among the at least one allocated process while the third memory retrieval operation is performed, stand by for a first delay time; and
end a second process selected from among the at least one process,
wherein the first delay time is shorter than a second delay time of the second memory retrieval operation, and
wherein the third memory retrieval operation secures the available capacity of the memory faster than the second memory retrieval operation.

3. The electronic device of claim 1, wherein the memory stores further instructions configured to further cause the electronic device to:
stop performing the third memory retrieval operation when an available capacity of the memory identified during the performing of the third memory retrieval operation is greater than the second threshold value; and
stop performing the second memory retrieval operation when an available capacity of the memory identified during the performing of the second memory retrieval operation is greater than the first threshold value.

4. The electronic device of claim 1, wherein the memory stores further instructions configured to further cause the electronic device to:
identify that the identified available capacity of the memory is less than the capacity threshold, and perform the first memory retrieval operation based on identifying that an available capacity of the memory identified by a request for allocating a process is less than or equal to a third threshold value,
perform the third memory retrieval operation before a second operation, and
wherein the first memory retrieval operation comprises a first operation and the second operation, the first operation being configured to retrieve first data of the at least one process allocated to a first area of the memory, and the second operation being configured to retrieve second data of the at least one process allocated to a second area of the memory.

5. The electronic device of claim 4, wherein the memory stores further instructions configured to further cause the electronic device to:
perform the first operation based on the identified available capacity, identified by the request for allocating the requested process, being less than or equal to the third threshold value;
perform the second operation based on an available capacity of the memory identified during the performing of the first operation being less than or equal to a fourth threshold value;
stop performing of the first operation based on the available capacity identified during the performing of the first operation is being greater than a fifth threshold value; and
stop performing of the second operation based on an available capacity identified during the performing of the second operation being greater than the fourth threshold value,
wherein the third threshold value is greater than the second threshold value, and
wherein the fourth threshold value is less than the second threshold value.

6. The electronic device of claim 1, wherein the memory stores instructions configured to cause the electronic device to,
in case that the third memory retrieval operation is performed, select one or more processes to be ended from among the at least one process allocated to the memory, based on at least one of a process size or a memory occupancy, and an importance value; and
end at least one of the one or more selected processes to be ended without identifying a specified process end condition.

7. The electronic device of claim 1, wherein the memory stores instructions configured to cause the electronic device to,
in case that the second memory retrieval operation is performed, select one or more processes to be ended from among the at least one process allocated to the memory, based on a specified process end condition and specified importance, and
end at least one of the one or more selected processes to be ended.

8. An operation method of an electronic device, comprising:
based on identifying that an available capacity for allocating a process to a memory of the electronic device is less than a capacity threshold, retrieving data of at least one process allocated to the memory and performing a first memory retrieval operation for increasing an available capacity of the memory;
identifying the available capacity of the memory, based on an event generated by the first memory retrieval operation;
performing a second memory retrieval operation, based on a value of the identified available capacity being less than or equal to a first threshold value and the identified available capacity being greater than a second threshold value; and
performing a third memory retrieval operation, based on a value of the identified available capacity being less than or equal to the first threshold value and the identified available capacity being less than or equal to the second threshold value,
wherein the first threshold value is greater than the second threshold value.

9. The operation method of claim 8, wherein the performing of the third memory retrieval operation comprises:
ending a first process selected from among the at least one allocated process while the third memory retrieval operation is performed;
standing by for a first delay time; and
ending a second process selected from among the at least one process,
wherein the first delay time is shorter than a second delay time of the second memory retrieval operation, and
wherein the third memory retrieval operation secures the available capacity of the memory faster than the second memory retrieval operation.

10. The operation method of claim 8, further comprising:
stopping the performing of the third memory retrieval operation when an available capacity of the memory identified during the performing of the third memory retrieval operation is greater than the second threshold value; and
stopping the performing of the second memory retrieval operation when an available capacity of the memory identified during the performing of the second memory retrieval operation is greater than the first threshold value.

11. The operation method of claim 8, wherein the performing of the first memory retrieval operation comprises:
identifying that the identified available capacity of the memory is less than the capacity threshold, based on identifying that the identified available capacity of the memory identified by a request for allocating a process, is less than or equal to a third threshold value.

12. The operation method of claim 8,
wherein the first memory retrieval operation comprises a first operation and a second operation, the first operation being configured to retrieve first data of the at least one process allocated to a first area of the memory, and the second operation being configured to retrieve second data of the at least one process allocated to a second area of the memory, and
wherein the third memory retrieval operation is performed before the second operation.

13. The operation method of claim 12, wherein the performing of the first memory retrieval operation comprises:
performing the first operation based on an available capacity of the memory identified by a request for allocating a process, being less than or equal to a third threshold value;
performing the second operation based on an available capacity of the memory identified during the first operation being less than or equal to a fourth threshold value;
stopping the performing of the first operation based on the available capacity of the memory identified during the performing of the first operation being greater than a fifth threshold value; and
stopping the performing of the second operation based on an available capacity of the memory identified during the performing of the second operation being greater than the fourth threshold value,
wherein the third threshold value is greater than the second threshold value, and
wherein the fourth threshold value is less than the second threshold value.

14. The operation method of claim 8, wherein:
the performing of the third memory retrieval operation comprises:
selecting one or more processes to be ended from among the at least one process allocated to the memory, based on at least one of a process size or a memory occupancy, and an importance value, and end the at least one selected process to be ended without identifying a specified process end condition; and
ending the at least one selected process to be ended, and
the performing of the second memory retrieval operation comprises:
selecting one or more processes to be ended from among the at least one process allocated to the memory, based on a specified process end condition;
selecting at least one process to be ended from among the processes allocated to the memory from among the at least one selected process, based on specified importance; and
ending at least one of the one or more selected processes to be ended.

15. A non-transitory computer-readable storage medium storing programs for operating an electronic device, the programs comprising executable instructions configured to, when executed by a processor of the electronic device, cause the electronic device to:
based on identifying that a first available capacity for allocating a process to a memory of the electronic device is less than a capacity threshold, retrieve data of at least one process allocated to the memory and perform a first memory retrieval operation for increasing an available capacity of the memory;
identify the available capacity of the memory, based on an event generated by the first memory retrieval operation;
perform a second memory retrieval operation, based on a value of the identified available capacity being less than or equal to a first threshold value and the identified available capacity being greater than a second threshold value; and
perform a third memory retrieval operation, based on a value of the identified available capacity being less than or equal to the first threshold value and the identified available capacity being less than or equal to the second threshold value,
wherein the first threshold value is greater than the second threshold value.
